(19) United States
(12) Patent Application Publication
(10) Pub. No.: US 2014/0121132 A1
(43) Pub. Date: May 1, 2014

(54) SYSTEMS AND METHODS FOR HIGH RESOLUTION BIOMOLECULAR IMAGING AND ANALYSIS

(71) Applicants: Aline Cerf, Toulouse (FR); Harold G. Craighead, Ithaca, NY (US); Thomas Alava, Grenoble (FR)

(72) Inventors: Aline Cerf, Toulouse (FR); Harold G. Craighead, Ithaca, NY (US); Thomas Alava, Grenoble (FR)

(73) Assignee: CORNELL UNIVERSITY, Ithaca, NY (US)

(21) Appl. No.: 14/004,601

(22) PCT Filed: Mar. 12, 2012
(86) PCT No.: PCT/US12/28753

§ 371 Date: Jan. 15, 2014

Related U.S. Application Data
(60) Provisional application No. 61/493,133, filed on Jun. 3, 2011.
(60) Provisional application No. 61/451,818, filed on Mar. 11, 2011.

(51) Int. Cl. B01J 19/00

(52) U.S. Cl. CPC B01J 19/0046
USPC 506/16; 506/40; 506/30

(57) ABSTRACT

The present invention relates to a system for producing a nucleic acid molecule imaging array for use in high resolution imaging of individual nucleic acid molecules. The system includes a micro/nanostructured capture array having a hydrophobic surface having topographical features effective to assist in capillary-based trapping and elongation of individual nucleic acid molecules. The system also includes a transfer platform having a support and a hydrophobic substrate layered on the support. The transfer platform is effective to receive and capture, through solvent mediation, the trapped and elongated individual nucleic acid molecules from the micro/nanostructured capture array. The present invention also relates to a nucleic acid molecule imaging array, a transfer platform for use in preparing a nucleic acid molecule array, and a kit for producing a nucleic acid molecule imaging array for use in high resolution imaging of individual nucleic acid molecules.

### CROSS-REFERENCE TO RELATED APPLICATIONS

This application claims priority benefit of U.S. Provisional Patent Application Ser. No. 61/451,818, filed Mar. 11, 2011, and U.S. Provisional Patent Application Ser. No. 61/493,133, filed Jun. 3, 2011, the disclosures of which are hereby incorporated by reference herein in their entirety.

### GOVERNMENT RIGHTS STATEMENT

This invention was made with Government support under grant number DA025722 awarded by the National Institutes of Health. The Government has certain rights in the invention.

### FIELD OF THE INVENTION

The present invention relates to, inter alia, a system and method for producing a nucleic acid molecule imaging array for use in high resolution imaging of individual nucleic acid molecules.

### BACKGROUND OF THE INVENTION

Direct imaging and identification of the identity of bases in individual deoxyribonucleic acid (DNA) molecules has been a long standing goal. In general, three things are required to do this. The first is a method with sufficient spatial resolution to resolve closely-spaced monomer units in the macromolecule. The second is a contrast mechanism to differentiate the base or monomer identity. The third is controlling the conformation of the long biopolymer so the order of the sequence monomer identities can be unambiguously determined. While various combinations of these requirements have been demonstrated, until now the three have not been simultaneously satisfied in one method. For example, numerous methods have been demonstrated for elongating DNA molecules on surfaces or in fluid channels [1-9] and these have been interrogated by optical imaging techniques with fluorescent labels for molecular identification. While the requirements on molecular conformation and contrast are satisfied, the optical techniques do not have the required practical spatial resolution. Scanned probes have the required spatial resolution, but the required contrast is not available. Transmission electron microscopy has the required spatial resolution [10] and energy loss spectroscopy has the possibility for elemental analysis with this spatial resolution. Therefore the observation of either native molecular elemental composition or the use of energy-loss labels is a possibility.

DNA is often characterized using fluorescence microscopy or atomic force microscopy, but few studies [15-18] have characterized or analyzed it by electron microscopy. In fact, light elements (with low atomic number) are essentially transparent to electron microscopes which generate contrast from the charges on atomic nuclei. DNA is mostly made of carbon, nitrogen, and oxygen, with small amounts of hydrogen and phosphorus giving an average atomic number of 5.5. DNA is, as a result, inherently low contrast for electron imaging.

Previous studies have reported the deposition of coiled double-stranded DNA or single-stranded oligonucleotides by incubation and drying of the molecules on graphene [19]. However, in such studies the molecules were adsorbed randomly on graphene in a coiled and globular shape. This is a problem since the characterization of DNA in its coiled state hinders obtaining information that can be more easily read from elongated molecules.

In fact, chromatin also contains valuable information in epigenetic or genetic disorders such as cancer. Thus, analyzing and identifying the placement of these epigenetic marks with single nucleotide resolution across the entire genome would represent a significant step forward.

The present invention is directed to overcoming these and other deficiencies in the art.

### SUMMARY OF THE INVENTION

In one aspect, the present invention relates to a system for producing a nucleic acid molecule imaging array for use in high resolution imaging of individual nucleic acid molecules. The system includes a micro/nanostructured capture array having a hydrophobic surface having topographical features effective to assist in capillary-based trapping and elongation of individual nucleic acid molecules. The system also includes a transfer platform having a support and a hydrophobic substrate layered on the support. The transfer platform is effective to receive and capture, through solvent mediation, the trapped and elongated individual nucleic acid molecules from the micro/nanostructured capture array.

In a second aspect, the present invention relates to a method of producing a nucleic acid molecule imaging array for use in high resolution imaging of individual nucleic acid molecules. This method involves (a) providing at least one individual elongated nucleic acid molecule removably coupled to a hydrophobic component; and (b) transferring the at least one individual elongated nucleic acid molecule to a transfer platform using solvent mediation, thereby yielding a nucleic acid molecule imaging array effective for use in high resolution imaging of the at least one elongated individual nucleic acid molecule. The transfer platform used in this method includes a support and a hydrophobic substrate layered on the support. Further, the transfer platform is effective to receive and capture, through solvent mediation, the at least one elongated individual nucleic acid molecule from the hydrophobic component.

In a third aspect, the present invention relates to a nucleic acid molecule imaging array produced according to the above method.

In a fourth aspect, the present invention relates to a transfer platform for use in preparing a nucleic acid molecule array. The transfer platform includes a support and a hydrophobic substrate layered on the support. The transfer platform is effective to receive and capture, through solvent mediation, a trapped and elongated individual nucleic acid molecule from a hydrophobic component.

In a fifth aspect, the present invention relates to a method of preparing a transfer platform for use in preparing a nucleic acid molecule array. This method involves (a) providing a support; and (b) layering a hydrophobic substrate onto the support to yield a transfer platform effective to receive and capture, through solvent mediation, a trapped and elongated individual nucleic acid molecule from a hydrophobic component. The hydrophobic substrate is layered onto the support at a thickness to allow electrons to pass through the hydrophobic substrate.

In a sixth aspect, the present invention relates to a transfer platform produced according to the above method.

In a seventh aspect, the present invention relates to a nucleic acid molecule array for use in high resolution imaging of individual nucleic acid molecules. The nucleic acid molecule array includes a transfer platform having a support and a hydrophobic substrate layered on the support; and at least one elongated nucleic acid molecule coupled to the hydrophobic substrate of the transfer platform.

In an eighth aspect, the present invention relates to a kit for producing a nucleic acid molecule imaging array for use in high resolution imaging of individual nucleic acid molecules. The kit includes a transfer platform having a support and a hydrophobic substrate layered on the support, where the transfer platform is effective to receive and capture, through solvent mediation, at least one trapped and elongated individual nucleic acid molecule from a hydrophobic component.

The present invention is useful in that it allows for the assembly of single stretched DNA molecules or chromatin fragments into regular arrays deposited on a micro/nanostructured stamp—e.g., a polydimethylsiloxane (PDMS) stamp—by means of capillary assembly, and transferring this assembly from the micro/nanostructured stamp to a hydrophobic surface (e.g., graphene TEM grids) using solvent mediation. As a result, the invention allows obtaining individual elongated molecules at predetermined locations on a hydrophobic surface (e.g., graphene surface), which then enables high throughput electron beam imaging and analysis with single nucleotide resolution. Thus, the present invention enables high contrast imaging of DNA molecules using techniques that involve, inter alia, scanning electron microscopy (SEM) or transmission electron microscopy (TEM).

Currently, TEM imaging of DNA is generally conducted by incubating coiled DNA at the surface of a TEM grid and staining it for imagery contrast. On the contrary, the present invention provides a straightforward, low-cost and high-throughput system and method to elongate and transfer single DNA molecules on graphene surfaces in one step. Therefore, the present invention enables, inter alia, imaging of DNA with single nucleotide resolution using electron microscopy.

Thus, a significant advancement over the existing art is that, in accordance with the present invention, DNA molecules are adsorbed into ordered arrays on graphene in an elongated manner, giving access to the molecules' full length and information.

These and other objects, features, and advantages of this invention will become apparent from the following detailed description of the various aspects of the invention taken in conjunction with the accompanying drawings.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, as provided, like reference numerals contained in the drawings are meant to identify similar or identical elements.

FIG. 1 is a schematic representation of one embodiment of a capillary assembly procedure of the present invention. Step 1: The liquid meniscus is dragged over the microstructured PDMS stamp. Step 2: The meniscus encounters the topographical features, gets pinned during a given time, and during this pinning time the molecules are trapped inside the wells by the capillary forces exerted. Step 3: The meniscus finally disrupts and releases the molecules while stretching them. Step 4: Final assembly of individual DNA molecule arrays on the microstructured PDMS stamp.

FIG. 2 is a schematic representation of one embodiment of a transfer-printing with solvent mediation procedure of the present invention. Step 1: A droplet of solvent (e.g., ethanol) is deposited on a substrate (e.g., a graphene substrate) and the PDMS stamp with assembled DNA molecules is put in contact with the wet surface. Step 2: The PDMS stamp is removed from the surface leaving the DNA molecules at the surface of the substrate (e.g., the graphene substrate).

FIG. 3 is a transmission electron micrograph of elongated DNA molecule on a graphene substrate.

FIGS. 4A-4B are images showing DNA transfer on CVD graphene. Fluorescence images of an array of single nucleic acid stained phage lambda DNA molecules transferred with solvent mediation onto a silicon dioxide surface with single-layer CVD graphene (excitation at 488 nm). FIG. 4B corresponds to a zoomed image of FIG. 4A.

FIGS. 5A, 5B, 5C, 5C1, and 5C2 are images showing DNA transfer on exfoliated graphene. Bright field (FIG. 5A), fluorescence (FIG. 5B) and atomic force microscope (FIG. 5C) images of the same area of a substrate after transfer of nucleic acid stained DNA molecules onto a silicon dioxide wafer with exfoliated graphene. In FIG. 5A, the dashed circle outlines a piece of exfoliated graphene. One can also observe the imprints of the PDMS stamp's microfeatures. In FIG. 5B, the dashed area corresponds to the same piece of graphene outlined in FIG. 5A. One can observe the array of the nucleic acid stained DNA molecule array (488 nm excitation). In FIG. 5C, the scanned area corresponds to the same area outlined in FIG. 5A and FIG. 5B, where one can recognize the exfoliated graphene piece on the bottom right surrounded by silicon dioxide. FIG. C1 and FIG. C2 show magnified atomic force microscope images and the corresponding cross-sections of the delimited areas in FIG. C. FIG. C1 shows a single DNA molecule on silicon dioxide, FIG. C2 shows a single DNA molecule on exfoliated graphene.

FIGS. 6A-6D are images showing DNA transfer on TEM grids with suspended graphene. FIG. 6A: Fluorescence image of a lacey carbon TEM grid with suspended single layer graphene after transfer of the nucleic acid stained DNA array. The arrows indicate the bright spots that are part of the periodic DNA molecule array. The DNA strands are not visible due to quenching effects. FIG. 6B: Transmission electron micrograph of elongated phage lambda DNA molecules on single layer graphene. The DNA molecules are not nucleic acid stained in this case. The distance between the molecules is short probably because the view shows adjacent patterns where one molecule is stretched up to the next pattern, nearly meeting the next molecule. FIG. 6C and FIG. 6D are higher magnification micrographs of the molecule on the right in FIG. 6B. The inset in FIG. 6D shows a theoretical computer-simulated representation of B-form DNA. It is observed that the pitch measured from the TEM micrograph is 1.35 times greater than the theoretical pitch of a B double helix.

FIGS. 7A-7C show the results of an EELS analysis. On the left (FIG. 7A), bright field image of a single DNA molecule. The frame corresponds to the scanned area for EELS. In the center (FIG. 7B), 20×20 EELS map from the insert in 7A, after energy filtering at 130 eV (PL₂₃ edge of phosphorous). This map was acquired with a 4 s dwell time per pixel. On the right (FIG. 7C), accumulation of EELS spectra extracted from the 20×20 map without energy filtering (90 eV-1140 eV window). The insert corresponds to the sum of pixels along the molecule only, with a background substraction (the energy window is reduced to 120 eV-200 eV). One can recognize the L₂₃ edge of phosphorous.

FIG. 8 is a scanning electron microscope image of suspended graphene sheets on TEM grids with ultra-thin lacey amorphous carbon film. The inset graph displays the Raman spectra measured on a suspended graphene sheet. The 2D peak's full width at half maximum is 39 cm⁻¹.

### DETAILED DESCRIPTION OF THE INVENTION

The present invention relates to, inter alia, a system and method for producing a nucleic acid molecule imaging array for use in high resolution imaging of individual nucleic acid molecules. The present invention generally is based on the unique combination of a hydrophobic micro/nano structured stamp to capture and elongate single nucleic acid molecules thereon, and the transfer of such elongated single nucleic acid molecules to another hydrophobic substrate using solvent mediation, thereby enabling the high resolution imaging of the single nucleic acid molecules on that hydrophobic substrate. Thus, the present invention may be used for high-resolution imaging and analysis of DNA for genetic or epigenetic studies, and generally expand the uses of electron microscopy in the field of biomolecular analysis.

The present invention provides a system for producing a nucleic acid molecule imaging array for use in high resolution imaging of individual nucleic acid molecules. The system includes a micro/nanostructured capture array having a hydrophobic surface having topographical features effective to assist in capillary-based trapping and elongation of individual nucleic acid molecules. The system also includes a transfer platform having a support and a hydrophobic substrate layered on the support. The transfer platform is effective to receive and capture, through solvent mediation, the trapped and elongated individual nucleic acid molecules from the micro/nano structured capture array.

As used herein, the term “capillary-based trapping and elongation of individual nucleic acid molecules” generally refers to any technique that uses capillary action to capture and then elongate a single nucleic acid molecule on a surface. For example, one suitable technique is commonly referred to as molecular combing, which has been described in U.S. Pat. No. 5,840,862, the disclosure of which is hereby incorporated by reference herein. U.S. Pat. No. 5,840,862 describes the idea of attaching DNA from one of its extremities to a surface and stretching the molecule by displacement of the meniscus of solvent containing the molecules, relative to the surface.

As used herein, the term “solvent mediation” refers to a method or technique that involves the use of a solvent to transfer a nucleic acid molecule from one surface to another surface. In one embodiment, the solvent used in the solvent mediation of the present invention can include, without limitation, ethanol, isopropanol, and aqueous solutions.

As used herein, the term “nucleic acid molecules” refers to deoxyribonucleic acid (DNA) molecules, ribonucleic acid (RNA) molecules, and mixtures thereof. The nucleic acid molecules can be from any source, including, without limitation, from an animal (including humans), a plant, a fungus, a bacterium, an algae, a protozoan, or a virus.

The hydrophobic surface of the micro/nanostructured capture array can be made of any hydrophobic material suitable for solvent mediation of the individual nucleic acid molecules from the micro/nanostructured capture array to the transfer platform. In one embodiment, the hydrophobic surface includes a polymer material. Examples of suitable polymer materials for use as the hydrophobic surface can include, without limitation, poly(dimethylsiloxane) (PDMS), parylene, poly(methylmethacrylate), polyethylenes, vinyls, and acrylates.

The hydrophobic surface of the micro/nanostructured capture array can be configured to have a variety of topographical features, as long as such features are effective to assist in capillary-based trapping and elongation of individual nucleic acid molecules. Various materials and methods of capillary-based trapping and elongation of individual nucleic acid molecules are known in the relevant art to those of ordinary skill. Thus, the present invention contemplates a micro/nanostructured capture array having a hydrophobic surface having topographical features that are known in the art for the above-identified function.

In one embodiment, the topographical features of the hydrophobic surface of the micro-nanostructured capture array can include, without limitation, one or more micro/nanowell. As used herein, the term “micro/nanowell” refers to a well-like structure of the micro/nanostructured capture array that has a depth or diameter (e.g., opening region at the surface) that is measured in micrometers or nanometers. For example, in one embodiment, the micro/nanowells have a diameter of between about 10 nanometers (nm) and about 50 micrometers (μm), and a depth of between about 10 nm and about 50 μm. Without any intent to being limited thereto, in a particular embodiment, the micro/nanowells can have a diameter of between about 3 μm and about 8 μm, a depth of between about 3 μm and about 5 μm, and a spacing between them of between about 20 μm and about 30 μm.

The micro/nanowells are fabricated using conventional photolithography. In practice, the fabrication of the micro/nanostructured hydrophobic surface first involves the fabrication of a micro/nanostructured silicon master. The silicon micro/nanostructured master is fabricated using photolithography for micrometric features, and using electron beam lithography in the case of nanometric features. Once the silicon master is generated with the desired protruding features, it undergoes a silanization step where a hydrophobic silane molecule is used to coat its surface. Then, an elastomer material, such as polydimethylsiloxane (PDMS), is poured in its liquid form onto the structured silicon master and cured in an oven (e.g., at 80° C. for 2 hours). The casted elastomer material (e.g., PDMS material) is finally peeled away, resulting in a PDMS replication of the initial silicon master's features. This PDMS replication thus consists of micro/nanowells that are then used as topographical pinpoints during the molecular elongation process.

In a particular embodiment, the hydrophobic surface is a plurality of micro/nanowells. The plurality of micro/nanowells can be of various arrangements. For example, the micro/nanowells can have substantially the same three-dimensional size and shape, or they can have a different three-dimensional sizes and a different three-dimensional shapes. The plurality of micro/nanowells can also be arranged in an orderly pattern (e.g., like rows and columns of a grid), or a more random pattern.

Examples of suitable shapes of the micro/nanowells can include, without limitation, asymmetric shapes, elliptical shapes, crosses, slots, drop-like shapes, triangular, square, rectangular, circular, and the like.

With regard to the transfer platform, the hydrophobic substrate of the transfer platform can be made of a graphene-containing hydrophobic compound including, without limitation, graphene, a graphene blend, a graphene derivative, a graphene composite, and/or a graphene-like compound, as long as such compounds are hydrophobic. In one embodiment, the hydrophobic substrate is layered onto the support of the transfer platform at a thickness to allow electrons to pass through the hydrophobic substrate. In a more particular embodiment, the thickness of the hydrophobic substrate is less than about 50 nanometers.

In one embodiment, the hydrophobic substrate is deposited onto the transfer platform by means of a transfer protocol in liquid or gas phase. For example, the hydrophobic substrate can be configured on a bottom substrate, which is ordinarily, but not always, made of a metal. A suitable transfer protocol includes the prior deposition of a top additive/intermediate material onto the hydrophobic substrate to preserve its mechanical integrity during the transfer protocol. The hydrophobic material is released from all underlying substrates by etching in the liquid phase. The support of the transfer platform is used from the liquid phase to scoop the hydrophobic material onto it, out of the liquid phase. The transfer platform thus constituted is dried to allow proper deposition and adsorption to the surfaces of the support. The top of the transfer protocol additive/intermediate material is dissolved at the end of the transfer protocol to allow the deposition and adsorption of the hydrophobic material onto the patterns of the transfer platform.

The support of the transfer platform can be made of materials such as silicon dioxide (SiO₂), molybdenum, silicon, silicon nitride, copper, gold, and carbon. The support can be prepared by manufacturing a network of through-hole apertures using conventional lithography techniques. A typical transfer platform of this kind is commercially available from manufacturers such as Ted Pella, Pacific Grid Tech, 2spi, Gilder Grids, and Agar Scientific, etc.

The present invention also provides a method of producing a nucleic acid molecule imaging array for use in high resolution imaging of individual nucleic acid molecules. This method involves (a) providing at least one individual elongated nucleic acid molecule removably coupled to a hydrophobic component; and (b) transferring the at least one individual elongated nucleic acid molecule to a transfer platform using solvent mediation, thereby yielding a nucleic acid molecule imaging array effective for use in high resolution imaging of the at least one elongated individual nucleic acid molecule. The transfer platform used in this method includes a support and a hydrophobic substrate layered on the support. Further, the transfer platform is effective to receive and capture, through solvent mediation, the at least one elongated individual nucleic acid molecule from the hydrophobic component. The present invention also relates to a nucleic acid molecule imaging array produced according to the above method.

As used herein, the term “high resolution imaging” refers to various imaging techniques that include, for example, transmission electron microscopy (TEM), scanning transmission electron microscopy (STEM), electron energy loss spectroscopy (EELS), scanning electron microscopy (SEM), electron tomography, energy-filtered transmission electron microscopy (EFTEM), X-ray spectroscopy, and Auger electron spectroscopy.

The hydrophobic component for use in this method can include a micro/nanostructured capture array having a hydrophobic surface having topographical features effective to assist in capillary-based trapping and elongation of individual nucleic acid molecules. Suitable micro/nanostructured capture arrays are as described herein.

Suitable transfer platforms for use in this method are as described herein above, and particularly include hydrophobic substrates made of graphene, a graphene blend, a graphene derivative, a graphene composite, or a graphene-like compound.

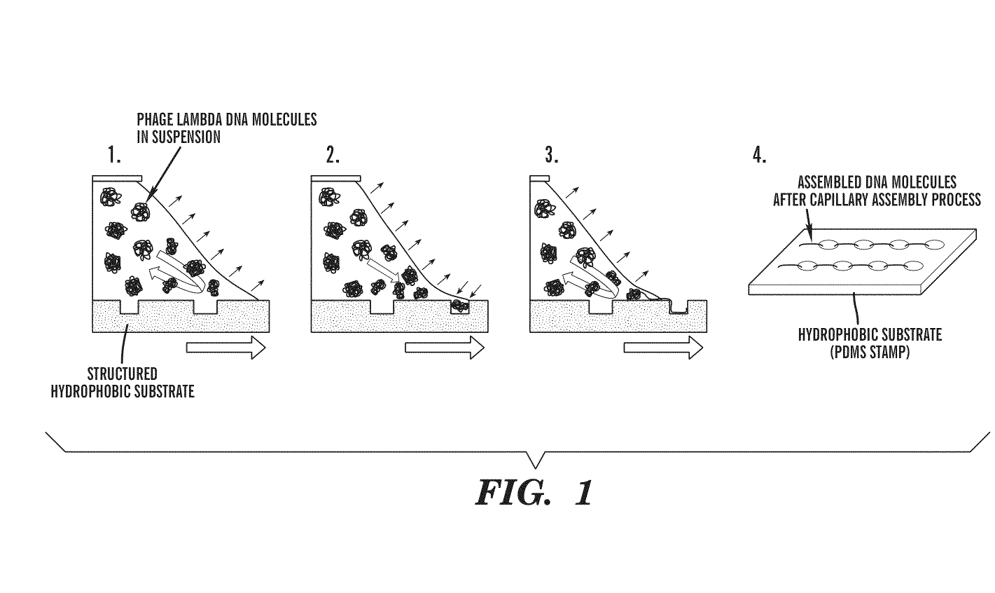

Referring now to FIG. 1, in one non-limiting embodiment of this invention, a microstructured PDMS stamp is placed on a translation stage with speed regulation. A droplet (e.g., about 10-40 μl) of DNA in solution is squeezed between the PDMS stamp and a fixed glass spreader. As the liquid meniscus is dragged over the PDMS stamp's surface at a controlled speed, the meniscus encounters the topographical wells of the PDMS stamp and gets pinned during a given time. During this pinning time, the molecules are trapped inside the wells by the capillary forces exerted and stretched when the meniscus finally disrupts. If the displacement speed and the concentration of the DNA molecules in solution are properly tuned—as an example, about 0.5-1 mm/sec and about 1-10 μg/mL, respectively—single molecules can be trapped and simultaneously stretched inside each topographical well of the PDMS stamp, leading to an array of single DNA molecules at the surface of the PDMS stamp.

The dimensions of the PDMS wells can be nanometric or micrometric as noted herein above. In one embodiment, the PDMS wells are between about 10 nm and about 100 μm in diameter, and more particularly between about 100 nm and about 50 μm in diameter. The depth of such wells are as described herein above for micro/nanowells. As understood by those of ordinary skill in the art, these dimensions are only limited by the lithography technique used to fabricate them. In the context of the phage lambda DNA molecules in particular, the PDMS features used to elongate and order the molecules measure about 3-8 μm in diameter and about 3-5 μm deep, with about 20-30 μm spacing between them. One of ordinary skill in the art can determine other particular parameters of the PDMS wells (micro/nanowells), depending on the type of DNA molecules they are interested in studying.

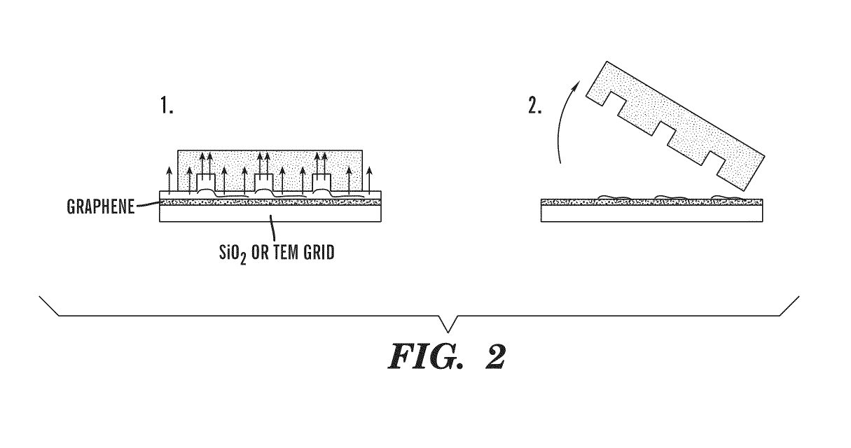

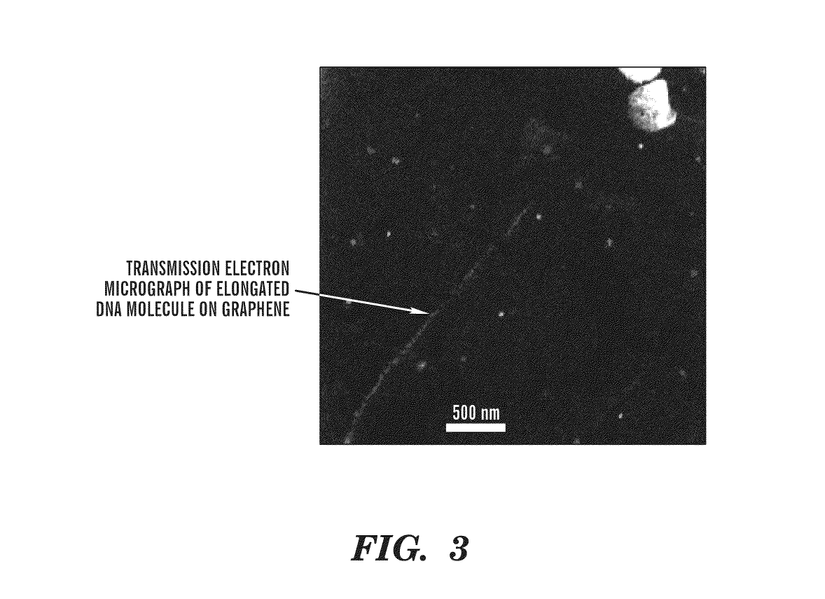

Referring now to FIG. 2, in another non-limiting embodiment of the present invention, the obtained DNA assembly can then be transferred onto a graphene TEM grid. First, the TEM grid is scotch-taped on a surface and a droplet of absolute ethanol is deposited on top. Ethanol is left to evaporate, but not completely. The PDMS stamp with assembled DNA molecules is then brought into contact with the wet graphene TEM grid for 2 minutes. Finally, the PDMS stamp is peeled off, leaving the DNA assembly at the surface of the graphene TEM grid. This process is extremely clean and free of any contamination. No further labeling of the molecules or staining of the grid is required.

The transfer protocol as shown in FIG. 2 can be extended to any type of hydrophobic surfaces. Solvents other than ethanol can be used to mediate the transfer process.

The present invention also provides a transfer platform for use in preparing a nucleic acid molecule array. The transfer platform includes a support and a hydrophobic substrate layered on the support. The transfer platform is effective to receive and capture, through solvent mediation, a trapped and elongated individual nucleic acid molecule from a hydrophobic component. One of ordinary skill in the art can readily determine the specific steps and materials required to make and use the transfer platform of the present invention.

The present invention also provides a method of preparing a transfer platform for use in preparing a nucleic acid molecule array. This method involves (a) providing a support; and (b) layering a hydrophobic substrate onto the support to yield a transfer platform effective to receive and capture, through solvent mediation, a trapped and elongated individual nucleic acid molecule from a hydrophobic component. The hydrophobic substrate is layered onto the support at a thickness to allow electrons to pass through the hydrophobic substrate. One of ordinary skill in the art can readily determine the specific steps, materials, and other aspects required to perform this method. The present invention further relates to a transfer platform produced according to the above method.

The present invention further provides a nucleic acid molecule array for use in high resolution imaging of individual nucleic acid molecules. The nucleic acid molecule array includes a transfer platform having a support and a hydrophobic substrate layered on the support; and at least one elongated nucleic acid molecule coupled to the hydrophobic substrate of the transfer platform. One of ordinary skill in the art can readily determine the specific steps and materials required to make and use the nucleic acid molecule array of the present invention.

The present invention also provides a kit for producing a nucleic acid molecule imaging array for use in high resolution imaging of individual nucleic acid molecules. The kit includes a transfer platform having a support and a hydrophobic substrate layered on the support, where the transfer platform is effective to receive and capture, through solvent mediation, at least one trapped and elongated individual nucleic acid molecule from a hydrophobic component. One of ordinary skill in the art can readily determine the specific steps, materials, and other aspects required to make the kit of the present invention.

The kit of the present invention can further include a hydrophobic component effective to trap and elongate at least one individual nucleic acid molecule from a source of nucleic acid molecules, where the hydrophobic component is effective for transferring, through solvent mediation, the at least one individual nucleic acid molecule to the transfer platform.

The kit of the present invention can also further include a solvent effective for use in solvent mediation of the at least one trapped and elongated individual nucleic acid molecule from the hydrophobic component to the transfer platform.

### EXAMPLES

The following examples are intended to illustrate particular embodiments of the present invention, but are by no means intended to limit the scope of the present invention.

### Example 1

### Transfer-Printing of Single DNA Molecule Arrays on Graphene for High Resolution Electron Imaging and Analysis

This example describes a new procedure for depositing ordered arrays of individual elongated DNA molecules on single-layer graphene substrates for high resolution electron beam imaging and electron energy loss spectroscopy (EELS) analysis. This demonstrates the capability to observe elemental composition of DNA with sufficient resolution to directly read genetic and epigenetic information with single base spatial resolution from individual elongated DNA molecules.

### Methods

Materials.

To prepare phage lambda DNA solution, 100 μl phage lambda DNA solution (Sigma, 48 502 bp, 329 μg/ml diluted to 50 μg/ml in 10 mM Tris-HCl/1 mM EDTA, pH 8) was heated at 65° C. for 5 min and dipped into ice water to avoid molecular concatenation. For fluorescence imaging, the solution was then fluorescently labeled with YOYO-1 intercalator (Invitrogen) by adding 1.5 μl of YOYO-1 (100 μM); incubation was conducted in the dark at room temperature for a minimum of 2 hours. Following the labeling reaction, samples were protected from light and stored at 4° C. Phage lambda DNA solution was further diluted to a final concentration of 10 μg/ml in the same buffer with 0.1% v/v Triton X-100. Note that for electron beam imaging, the DNA molecules were used unlabeled.

TEM grids coated with ultra-thin lacey carbon were purchased from Pacific Grid Tech (San Francisco, Calif.).

Fabrication of Master and Stamps.

To direct the capillary assembly of phage lambda DNA or chromatin, applicants used PDMS stamps with topographical cavities obtained from the replication of a positive silicon master. The silicon micropatterned master was achieved by ultraviolet photolithography and the pattern transfer by deep reactive ion etching. The PDMS prepolymer solution containing a mixture of 10:1 mass ratio of PDMS oligomers and a reticular agent from Sylgard 184 Kit (Dow Corning, Wilmington, Del.) was then poured onto the silicon master and cured at a temperature of 80° C. during 12 hours. The cured PDMS was peeled off and cut into 1 cm×1 cm stamps.

In a general manner, the design of the topographic patterns requires a prior reflexion in terms of distribution, dimension, depth, and orientation. In fact, the size of the patterns determines the number and the positioning of the objects to be assembled for assemblies of controlled geometry. Given the dispersion in size of the objects in solution, the patterns are usually intentionally enlarged to facilitate the assembly by compensating the fluctuations in size among the objects. The depth of the patterns is also a key geometrical parameter to take into consideration as it determines the number of layers to be deposited inside the patterns and ensures the subsequent transfer of the assembled objects. When the stamp is used as support for capillary assembly, the design rule to keep in mind is that the deformation of the liquid contact line has to be minimized in order to avoid its premature disruption, and allow the forces involved to direct and gather the objects at the liquid front line to fill the cavities appropriately. So additionally, the periodicity of the patterns has to be large enough so the contact line can get pinned on each row of patterns without missing one. In the case of DNA molecules' assembly, the silicon master was designed with protruding microfeatures 5 μm and 8 μm in diameter, 5 μm high and with different periodicities (20 μm, and 25 μm). Therefore, the corresponding PDMS stamps are the negatives of the master and consist of microcavities with the same sizes.

Experimental Setup.

The so-called directed assembly is carried out using a dedicated setup. The microstructured PDMS stamp where applicants want the DNA molecules to be assembled is placed on a motorized translation stage below a fixed glass spreader at a distance of about 1 mm. A 15 μl droplet of DNA molecules in solution at a concentration of 10 μg/ml is injected between the glass and the substrate. The liquid contact line is therefore moved over the substrate at a constant velocity of 0.5 mm/sec for the trapped DNA molecules to be stretched. The experiment is conducted at ambient temperature. The experimental parameters (speed, concentration) are adjusted to enable the directed assembly and combing of single DNA molecules with high placement accuracy. The assembly is performed throughout the entire surface of the PDMS stamp, so approximately over an area of more than 1 cm², allowing the analysis of approximately 1 million molecules over an entire substrate.

Graphene Deposition on SiO₂ Surfaces or TEM Grids.

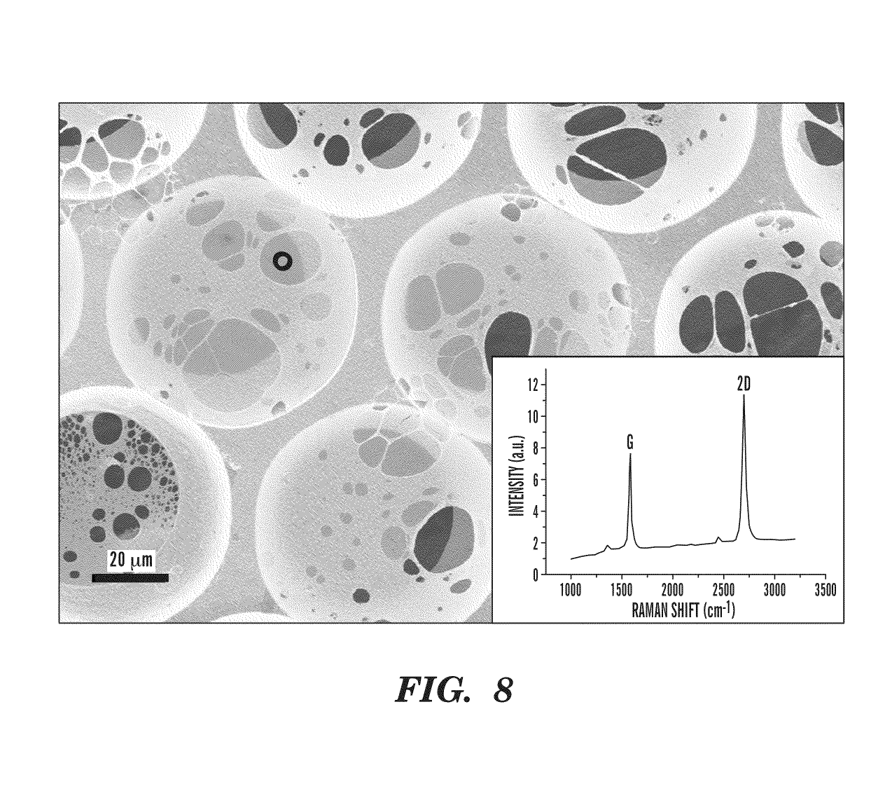

Graphene was grown using chemical vapor deposition on copper foils [28]. It was verified to be predominantly single-layer by Raman spectroscopy [29]. The graphene sheets were then transferred on silicon dioxide substrates or molybdenum TEM grids with lacey carbon support films following the graphene transfer technique developed in [30]. After chemical vapor deposition, a 50 nm-thick poly(methyl-methacrylate) (PMMA) film was spin-coated on the copper foil. Copper was etched in a ferric chloride solution; the graphene/PMMA was then transferred on TEM grids and PMMA was dissolved in a dichloromethane bath for 6 hours [28, 31]. FIG. 8 displays the scanning electron microscope image of single layer graphene suspended over the lacey carbon TEM grids. For AFM imaging, graphene was prepared by mechanical exfoliation [32] and deposited on a freshly cleaned silicon dioxide substrate.

DNA Assembly Transfer.

To transfer the formed DNA arrays, a droplet of solvent (absolute ethanol) is placed on the graphene substrate (graphene on SiO₂ or on TEM grids). Ethanol having a low surface tension, it spreads easily creating a thin film of liquid all over the substrate. Ethanol is then left to evaporate, but not fully, and the PDMS stamp with the assembled DNA molecules is then brought into contact with the wet graphene substrate for 2-3 min for the solvent to fully evaporate. The PDMS stamp is then peeled away (FIG. 1).

Imaging.

The molecules' transfer on graphene was controlled under an upright epifluorescence microscope (×20 and ×50 objectives) from Olympus equipped with a 512×512 camera.

AFM imaging. For AFM imaging and measurements applicants used a NanoScope IIIa from Digital Instruments. All imaging was done in tapping mode in air, with a resolution of 512×512 using NC silicon AFM probes (Bruker Company).

STEM and EELS analysis. STEM imaging was performed using a field emission transmission electron microscope with monochromator (Tecnai F20) operated at 200 kV, with a 200 mm camera in dark field mode. EELS mapping was conducted within a 90 eV-1140 eV window, with a 4 seconds acquisition time, and a 0.5 eV dispersion. The resulting map was then filtered at an energy loss of 130 eV using Cornell Spectrum Imager software.

### DISCUSSION

Elongation of molecules for direct electron imaging has been an issue that applicants have been addressing. Applicants have shown, for example, that electrospinning of DNA in nanofibers can present individual elongated DNA molecules in a thin support medium for electron beam analysis [1-2], but the thickness of the supporting medium limits the possibilities for elemental and spatial analysis. The ideal case would be to have no supporting medium, but this is of course not possible. The best possible case would be to have a high-strength, electrically-conducting, single element, low atomic number support on which one could reliable elongate and place molecules. The best candidate for this is single-atom-thick graphene [11-14]. In this example applicants demonstrate a reliable technique for elongating individual DNA molecules and transferring them in ordered arrays to a single-atom-thick mechanical support layers for high resolution scanning transmission electron microscopy and elemental analysis by electron energy loss spectroscopy. This approach satisfies the three requirements mentioned previously and adds the advantage of being able to pre-treat the DNA and create spatial order that can simplify the analysis. While the complexity of the STEM systems limits the throughput and practicality of this approach it demonstrates the possibilities for electron beam analysis of individual biopolymers.

In the present example, applicants present as just one part of the method a technique to transfer regular arrays of individual elongated DNA molecules onto single-layer graphene substrates. This aspect of the method relies on assembling DNA on a microstructured PDMS stamp by capillary assembly. Applicants previously reported this aspect of the experimental procedure [20-21] to transfer arrays of single phage lambda DNA molecules from a PDMS stamp to a hydrophilic and positively-charged surface by simple contact in dry conditions. Here, graphene being highly hydrophobic, the transfer is performed with solvent mediation. Applicants obtain regular arrays of single phage lambda DNA molecules adsorbed on graphene following a Poissonian distribution with a 91% success rate [22]. Applicants prove, for the first time, that subsequent imaging of the assembled molecules is possible using a transmission electron microscope without any prior metallization or labeling of the DNA molecules.

In the so-called directed assembly technique, patterning is used to create a well-defined spatial distribution of forces that direct the motion of molecules in solution towards specific areas of a substrate. In the present case, applicants use a PDMS stamp with topographical features to direct that assembly process. The experimental parameters, namely, the concentration and the displacement speed are chosen to trap and stretch individual molecules. After capillary assembly, the resulting DNA array is transferred onto the graphene substrate. In practice, applicants deposit a droplet of ethanol not fully allowed to dry on the graphene substrate and the PDMS stamp is brought into contact with that wet surface for 2 min. The solvent placed between the PDMS stamp and the substrate during contact mediates the transfer. The PDMS stamp is finally removed, leaving the DNA array on the graphene surface (FIG. 1).

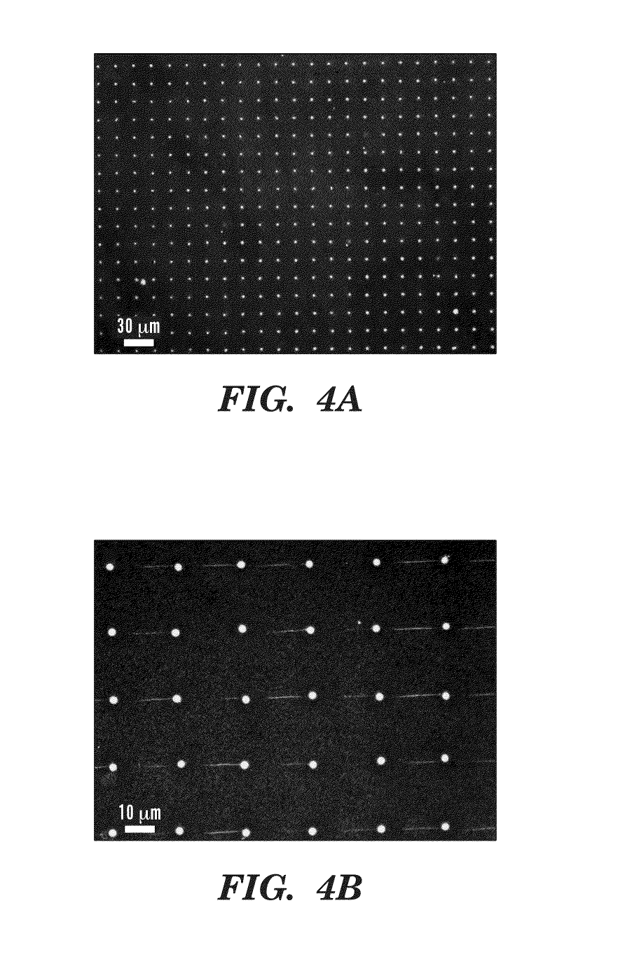

In general, for the transfer to occur, the molecules need to have more affinity for the target surface than for the PDMS stamp's surface. In the present case, the two surfaces are highly hydrophobic (PDMS vents graphene) with a measured contact angle of 108°±2° and 92°±2° respectively, so when the contact is made in dry conditions, the molecules are not naturally transferred from the stamp to the graphene surface. FIG. 4 shows a fluorescence micrograph of individual DNA molecules transferred to CVD graphene on silicon dioxide with solvent mediation. Applicants observe that the transfer is performed reliably over large areas. All the molecules present at the surface of the PDMS stamp are transferred. Furthermore, applicants observe the presence of periodic fluorescent spots that correspond to the material initially contained in the PDMS wells during capillary assembly. The transfer method is so effective that even the material trapped and not directly in contact with the surface is transferred.

However, not all liquids or solvents are proper to transfer the assemblies from a PDMS stamp onto a substrate. In the present case, the category of good solvents such as trichloroethylene, hexane, toluene are to be excluded as they irreversibly deform and damage the PDMS stamp, and are not compatible with biology in a more general manner. In this regard, water could have been a candidate to consider, but its surface tension in the presence of a hydrophobic surface prevents the creation of a thin layer of liquid and prevents the PDMS stamp from contacting the surface in a conformal manner as well. Consequently, applicants suggest different hypotheses concerning the influence of ethanol. On the one hand, compared to ethyl acetate for example, ethanol only exerts a swelling extent of 6.3% on a weight basis of bulk PDMS [23]. But this swelling may modify in some manner the PDMS features and facilitate the release of the assembled molecules. On the other hand, during contact of the stamp with the substrate, in liquid, the evaporation process may lead to the creation of capillary forces that direct the elongated molecules towards the wetting target surface. Thus, the natural evaporation process may facilitate the release of the trapped and elongated molecules. However, it is still difficult to know which one of these candidates is responsible for molecule transfer.

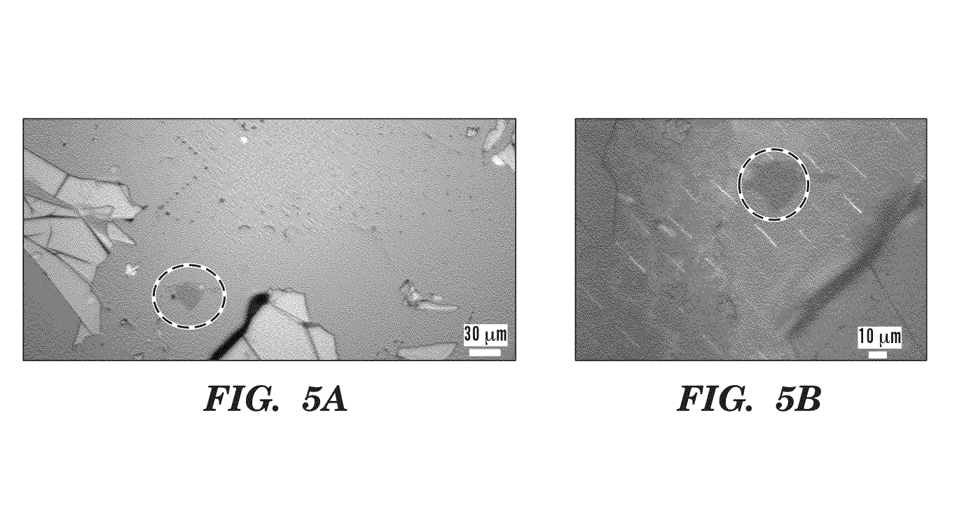

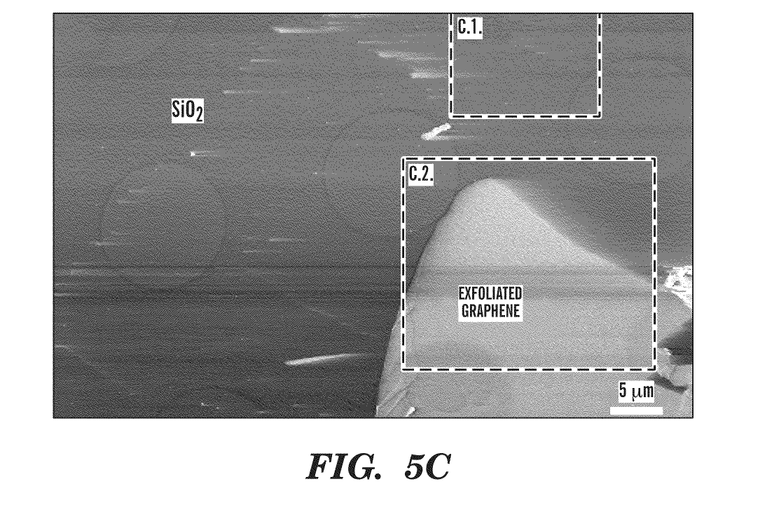

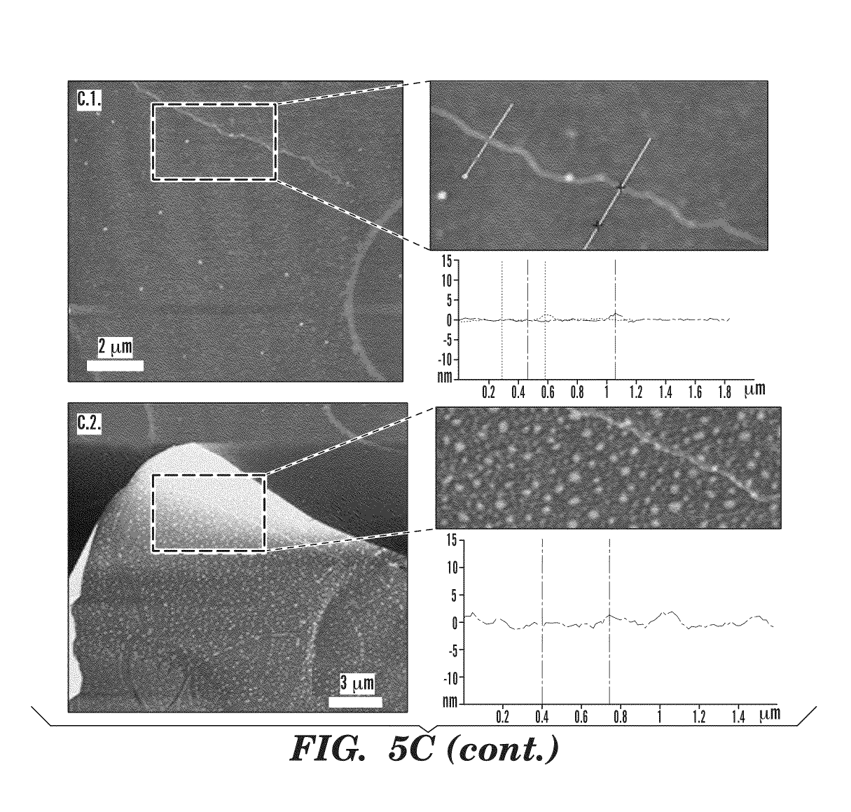

Applicants also notice that the fluorescence intensity of YOYO-1 intercalated DNA molecules on graphene is somewhat lower than the fluorescence intensity one could obtain with molecules transferred onto glass. This suggests that there is a certain degree of quenching provoked by graphene, in agreement with previous results [24]. This, however, does not prevent the characterization of molecules using fluorescence microscopy. To further demonstrate that the DNA array is composed of individual molecules, applicants performed the transfer on exfoliated graphene for AFM imaging. The presence of residual iron particles ˜10 nm in diameter on the CVD graphene after its transfer to silicon dioxide inhibits the proper characterization of individual molecules with such a technique. Thus applicants chose exfoliated graphene, well-known for its atomically-flat surface as our substrate for AFM imaging purposes. FIG. 5 shows a bright field, fluorescence and AFM image of the same area of a silicon dioxide substrate with exfoliated graphene after transfer of a DNA array. In the bright field image applicants observe the presence of the PDMS stamp feature imprints. In the fluorescence image, FIG. 5B, the elongated DNA molecule which is part of the array and positioned on the exfoliated graphene is not visible possibly due to quenching. However, its presence can be detected by AFM. FIG. 5C1 shows an enlarged image of a DNA molecule on silicon dioxide. From the corresponding cross-section applicants observe that it is a single molecule measuring 1.57 nm in height. FIG. 5C2 shows a magnified image of a DNA molecule on exfoliated graphene. In contrast to the measurement on silicon dioxide, the roughness is comparable to the height of the molecule (2 nm on average). Applicants attribute this roughness to impurities attracted to exfoliated graphene during the transfer process that we do not observe on silicon dioxide. The measurements from the different AFM and fluorescence images show that the DNA molecules measure in average 16.3 μm±4.4 μm long, which is approximately equal to the theoretical length of individual phage lambda DNA molecules [25].

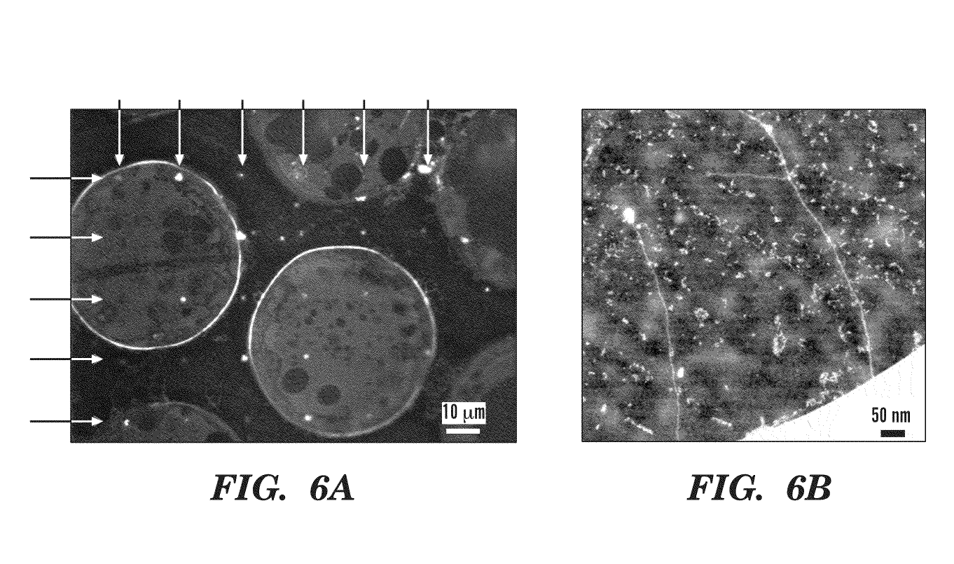

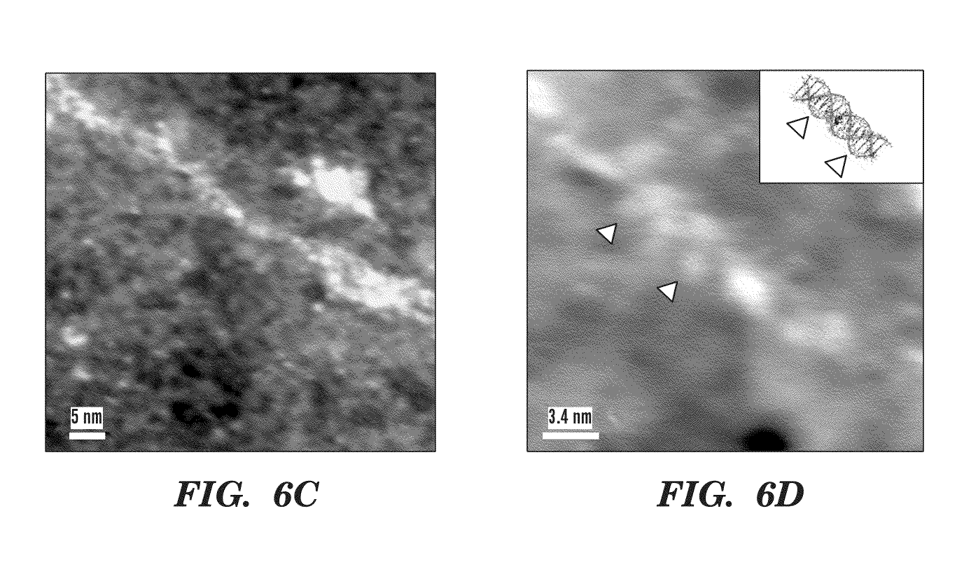

By extension, the transfer process can be performed on any type of graphene substrates such as TEM grids with lacey carbon support films. In this case, commercial molybdenum TEM grids pre-coated with a web of amorphous carbon fibers (lacey carbon) are used as a support to suspend atomically-thick graphene films. FIG. 6A shows a fluorescence image of nucleic acid-stained DNA molecules transferred on this type of grid. From this image applicants recognize the bright spots corresponding in periodicity to the patterns of the PDMS stamp. However, single molecules are not visible by fluorescence as the autofluorescence of the grid is much higher than that of silicon dioxide. FIGS. 6B, 6C, and 6D show the transmission electron micrographs obtained from DNA elongated and adsorbed on lacey carbon grids with suspended graphene. Note that no plasma treatment or heating step was required prior to imaging. First, applicants observe that the images show little charging or contamination. This implies that applicants' methodology as a whole is very clean and adapted to high resolution imaging purposes. Second, applicants observe that suspended single-layer graphene sheets remain on the grid after transfer, so the forces exerted during PDMS peel-off are low enough to prevent graphene from rupturing. Third, while DNA could not be imaged using standard TEM grids without prior labeling, on single-layer graphene TEM grids DNA can be characterized with no difficulties and long exposure times. DNA appears to be undamaged after transfer, measuring 2-3 nm wide in the case of single molecules. If applicants compare the outside region of the lacey carbon and the inner area (FIG. 6B), applicants can see that the contrast in the presence of suspended graphene is much higher. FIGS. 6C and 6D show higher magnification micrographs of the region shown in FIG. 6B, where the molecule seems to present a B conformation with a 4.6 nm pitch. The periodicity of the double-helix is in this case 1.35 times greater than the theoretical pitch reported by Watson and Crick [26], but these observations seem consistent with the ones reported in literature in similar conditions [16-17, 27]. Instead of considering the inelastic energy as a whole, the spectral distribution of the forward scattered electrons can be analyzed separately. A highly specific signature lies in the characteristic core-loss edges: their energy position corresponds to a given atomic level and therefore identifies a given element within the irradiated volume.

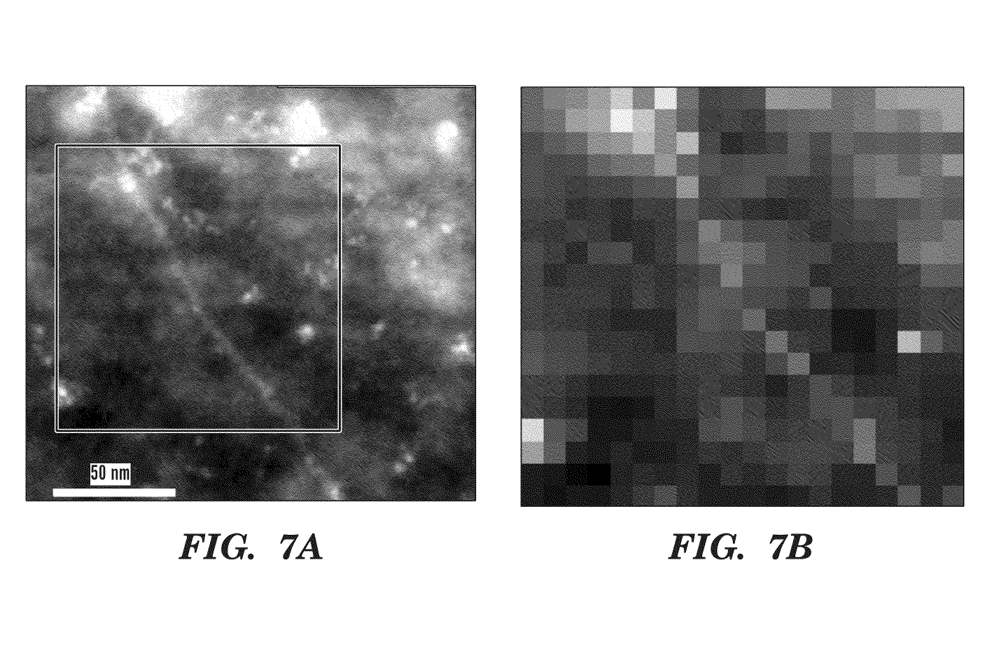

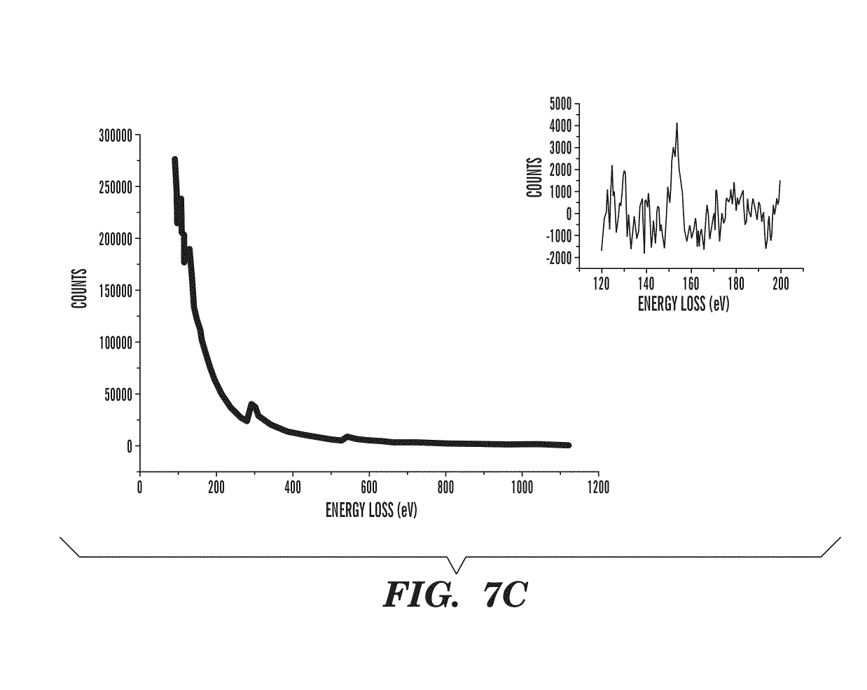

A way of exploiting electron energy loss spectroscopy (EELS) is to produce images representative of elemental distribution by scanning the probe, recording several energy-filtered images on both sides of the core-loss edge, and processing them pixel by pixel display maps of the resulting characteristic signal. Applicants know that the support is constituted by a molybdenum lacey-carbon grid and graphene, both composed primarily of molybdenum, iron, and carbon elements. Applicants selected an area with elongated DNA molecules as shown by the bright field image (FIG. 7A), and applicants recorded a 20×20 EELS mapping with a 4 seconds acquisition time per pixel. Interested in obtaining a characteristic signature of DNA, applicants then filtered the resulting map at an energy-loss of 130 eV corresponding to the edge of phosphorous. Although the total acquisition time was close to 1 hour, the specimen remained stable and no noticeable change of the phosphorous energy loss signal was observed. The presence of phosphorous is observed all along the molecule (FIG. 7B). This suggests that phosphorous can be used as an indicator of individual bases. If the DNA molecule can be formed with non-native elemental labels on the different bases, the energy filtered images can reveal the base sequence. As shown in FIG. 7C, applicants notice from the accumulated spectra extracted from the entire map without energy filtering, the K edges of carbon (285 eV), nitrogen (400 eV) and oxygen (532 eV) as expected. Applicants see at around 130 eV the L₂₃ edge of phosphorous corresponding to the excitation of 2p electrons. Note that in that range, applicants also observe the L₂₃ edge of silicon (99 eV) more likely coming from PDMS residues during transfer.

By combining directed assembly on a PDMS stamp and microcontact printing with solvent mediation, applicants benefit from the advantages of both techniques at the same time: the control over the assembly process and the flexibility and simplicity of the printing technique. This printing method can handle single objects while preserving their intrinsic properties. It is adaptable to parallel processing over various hydrophilic/hydrophobic substrates and over large areas. In particular, the transfer on graphene opens a wide horizon of possible applications and could be an invaluable technique in MEMS/NEMS technologies but also to allow high resolution imaging of single DNA molecules using electron microscopy in a regular basis for applications in epigenetic and genetic analysis.

By extension, we envision using this protocol to transfer base-labeled DNA and elongated chromatin with energy-loss resolved epigenetic labels. With this process, one can obtain a complete genetic and epigenetic map from individually selected chromosomes without the need for polymerase chain reaction. A STEM is not designed to be a cost-effective sequencing system, however, the possibility for directly reading single molecule information with the spatial resolution of electron beams is possible.

### REFERENCES

Citation of a reference herein shall not be construed as an admission that such reference is prior art to the present invention. The following references, to the extent that they provide exemplary procedural or other details supplementary to those set forth herein, are specifically incorporated herein by reference:
[1] Bellan, L. M., Strychalski, E. A., Craighead, H. G. Electrospun DNA nanofibers. J. Vac. Sci. Technol. B 25, 2255-2257 (2007);
[2] Bellan, L. M., Cross, J. D., Strychalski, E. A., Mirabal, J. M., Craighead, H. G. Individually resolved DNA molecules strectched and embedded in electrospun polymer nanofibers. Nano Lett. 6, 2526-2530 (2006);
[3] Reccius, C. H., Stavis, S. M., Mannion, J. T., Walker, L. P., Craighead, H. G.
Conformation, length, and speed measurements of electrodynamically stretched DNA in Nanochannels. Biophys. Jour. 95, 273-286 (2008);
[4] Bensimon, D., Bensimon, A., Heslot, F. U.S. Pat. No. 5,840,862 (1998);
[5] Bensimon D., Simon A. J., Croquette, V., Bensimon, A. Stretching DNA with a receding meniscus: experiments and models. Phys. Rev. Lett. 74, 4754-4757 (1995);
[6] Bensimon, A. et. al. Alignement and sensitive detection of DNA by a moving interface. Science 265, 2096-2098 (1994);
[7] Guan, J., Lee, L. J., Generating highly ordered DNA nanostrand arrays. Proc. Natl Acad. Sci. USA 102, 18321-18325 (2005);
[8] Armbrust, E. V. et. al. The genome of the diatom Thalassiosira pseudonana: ecology, evolution, and metabolism. Science 306, 79-86 (2004);
[9] Dimalanta, E. T. et. al. A microfluidic system for large DNA molecule arrays. Anal. Chem. 76, 5293-5301 (2004);
[10] Huang, P. Y. et, al. Grain and, grains boundaries in single-layer graphene atomic patchwork quilts. Nature 469, 389-393 (2011):
[11] Geim, A. K. Graphene: status and prospects. Science 324, 1530-1534 (2009);
[12] Lee, C., Wei, X. D., Kysar, J. W., Hone, J. Measurement of the elastic properties and intrinsic strength of monolayer graphene. Science 321, 385-388 (2008);
[13] Meyer, J. C., Girit, C. O., Crommie M. F., Zettl, A. Imaging and dynamics of light atoms and molecules on graphene. Nature 454, 319-322 (2008);
[14] Nair, R. R. et. al. Graphene as a transparent conductive support for studying biological molecules by transmission electron microscopy. Appl. Phys. Lett. 97, 153102-1-153102-3 (2010);
[15] Mory, C., Colliex, C., Revet, B., Delain, E. Improved visualization of single- and double-stranded nucleic acids by STEM. Ultramicroscopy 7, 161-168 (1981);
[16] Fujiyoshi, Y., Uyeda, N. Direct imaging of a double-strand DNA molecule. Ultramicroscopy 7, 189-192 (1981);
[17] Inaga, S., Osatake, H., Tanaka, K. SEM images of DNA double helix and nucleosomes observed by ultrahigh resolution scanning electron microscopy. J. Electron Microsc. 40, 181-186 (1991);
[18] Younghusband, B., Inman, R. B. The electron microscopy of DNA. Ann. Rev. Biochem. 43, 605-619 (1974);
[19] Husale, B. S. et. al. ssDNA binding reveals the atomic structure of graphene. Langmuir: ACS J. of surf. and coll. 6, 18078-18082 (2010);
[20] Cerf, A., Thibault, C., Genevieve, M., Vieu, C. Ordered arrays of single DNA molecules by a combination of capillary assembly, molecular combing and soft-lithography. Microelec. Eng. 86, 1419-1423 (2009);
[21] Cerf, A., et. al. A versatile method for generating single DNA molecule patterns: through the combination of directed capillary assembly and (micro/nano) contact printing. J. Mater. Res. 26, 336-346 (2010);
[22] Cerf. A. Directed assembly of nano-objects, Toulouse University (2010);
[23] Favre, E. Swelling of crosslinked polydimethylsiloxane networks by pure solvents: influence of temperature. Europ. Polym. Jour. 32, 1183-1188 (1996);
[24] Kim, J. Cote, L. J., Kim, F., Huang, J. Visualizing graphene based sheets by fluorescence quenching microscopy. J. of the Am. Chem. Soc. 132, 260-267 (2010);
[25] Smith, D. E., Perkins, T. T., Chu S. Dynamical scaling of DNA diffusion coefficients. Macromolecules 29, 1372-1373 (1996);
[26] Watson, J. D., Crick, F. H. C. Molecular structure of nucleic acids Nature 171, 737-738 (1953);
[27] Arnott, S. Is DNA really a double helix? Nature 278, 780-781 (1979);
[28] Li, X. et. al. Large-area synthesis of high-quality and uniform graphene films on copper foils Science 324, 1312-1314 (2009);
[29] Ferrari, A. et. al. Raman spectrum of graphene and graphene layers. Phys. Rev. Lett. 97, 1-4 (2006);
[30] Reina, A. et. al. Large area, few-layer graphene films on arbitrary substrates by chemical vapor deposition. Nano letters 9, 30-35 (2009);
[31] Jiao, L. et. al. Creation of nanostructures with poly(methyl methacrylate)-mediated nanotransfer printing. J. Am. Chem. Soc. Comm. 130, 12612-12613 (2008); and
[32] Novoselov, K. S. et. Al. Electric field effect in atomically-thin carbon films. Science 306, 666-669 (2004).

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A system for producing a nucleic acid molecule imaging array for use in high resolution imaging of individual nucleic acid molecules, said system comprising:
a micro/nanostructured capture array comprising a hydrophobic surface having topographical features effective to assist in capillary-based trapping and elongation of individual nucleic acid molecules; and
a transfer platform comprising a support and a hydrophobic substrate layered on the support, wherein said transfer platform is effective to receive and capture, through solvent mediation, the trapped and elongated individual nucleic acid molecules from the micro/nanostructured capture array.

2. The system according to claim 1, wherein said hydrophobic surface of the micro/nanostructured capture array comprises a polymer material.

3. The system according to claim 2, wherein said polymer material is selected from the group consisting of poly(dimethylsiloxane), parylene, poly(methylmethacrylate), polyethylenes, vinyls, and acrylates.

4. The system according to claim 1, wherein said topographical features comprise a plurality of micro/nanowells.

5. The system according to claim 4, wherein said plurality of micro/nanowells comprises micro/nanowells that have substantially the same three-dimensional size and shape or comprises micro/nanowells that have a different three-dimensional size, a different three-dimensional shape, or both a different three-dimensional size and shape.

6. The system according to claim 4, wherein the micro/nanowells comprise the same or different shapes selected from the group consisting of asymmetric shapes, elliptical shapes, crosses, slots, drop-like shapes, triangular, square, rectangular, circular, and the like.

7. The system according to claim 4, wherein the micro/nanowells have a diameter of between about 10 nanometers (nm) and about 50 micrometers (μm).

8. The system according to claim 4, wherein the micro/nanowells have a diameter of between about 3 μm and about 8 μm, a depth of between about 3 μm and about 5 μm, and a spacing between them of between about 20 μm and about 30 μm.

9. The system according to claim 1, wherein said hydrophobic substrate of the transfer platform is a compound selected from the group consisting of graphene, a graphene blend, a graphene derivative, and a graphene-like compound.

10. The system according to claim 1, wherein said hydrophobic substrate is layered onto the support at a thickness to allow electrons to pass through the hydrophobic substrate.

11. The system according to claim 1, wherein the thickness of the hydrophobic substrate is less than about 50 nanometers.

12. The system according to claim 1, wherein said support of the transfer platform comprises silicon dioxide (SiO₂), molybdenum, silicon, silicon nitride, copper, gold, and carbon.

13. The system according to claim 1, wherein the solvent in said solvent mediation is selected from the group consisting of ethanol, isopropanol, and aqueous solutions.

14. The system according to claim 1, wherein the nucleic acid molecules are selected from the group consisting of deoxyribonucleic acid (DNA) molecules, ribonucleic acid (RNA) molecules, and mixtures thereof.

15. A method of producing a nucleic acid molecule imaging array for use in high resolution imaging of individual nucleic acid molecules, said method comprising:
(a) providing at least one individual elongated nucleic acid molecule removably coupled to a hydrophobic component; and
(b) transferring said at least one individual elongated nucleic acid molecule to a transfer platform using solvent mediation, thereby yielding a nucleic acid molecule imaging array effective for use in high resolution imaging of the at least one elongated individual nucleic acid molecule,
wherein said transfer platform comprises a support and a hydrophobic substrate layered on the support, and
wherein said transfer platform is effective to receive and capture, through solvent mediation, the at least one elongated individual nucleic acid molecule from said hydrophobic component.

16. The method according to claim 15, wherein said high resolution imaging comprises imaging techniques selected from the group consisting of transmission electron microscopy (TEM), scanning transmission electron microscopy (STEM), electron energy loss spectroscopy (EELS), scanning electron microscopy (SEM), electron tomography, energy-filtered transmission electron microscopy (EFTEM), X-ray spectroscopy, and Auger electron spectroscopy.

17. The method according to claim 15, wherein said hydrophobic component comprises a micro/nanostructured capture array comprising a hydrophobic surface having topographical features effective to assist in capillary-based trapping and elongation of individual nucleic acid molecules.

18-31. (canceled)

32. A nucleic acid molecule imaging array produced according to the method of claim 15.

33. (canceled)

34. A method of preparing a transfer platform for use in preparing a nucleic acid molecule array, said method comprising:
providing a support; and
layering a hydrophobic substrate onto the support to yield a transfer platform effective to receive and capture, through solvent mediation, a trapped and elongated individual nucleic acid molecule from a hydrophobic component,
wherein said hydrophobic substrate is layered onto the support at a thickness to allow electrons to pass through the hydrophobic substrate.

35-37. (canceled)

38. A transfer platform produced according to the method of claim 34.

39-43. (canceled)
